(19) United States
(12) Patent Application Publication
(10) Pub. No.: US 2023/0386014 A1
(43) Pub. Date: Nov. 30, 2023

(54) MODEL GENERATION DEVICE FOR VISUAL INSPECTION AND VISUAL INSPECTION DEVICE

(71) Applicant: FANUC CORPORATION, Yamanashi (JP)

(72) Inventor: Yuuji KOUNOSU, Yamanashi (JP)

(21) Appl. No.: 18/044,993

(22) PCT Filed: Sep. 21, 2021
(86) PCT No.: PCT/JP2021/034499

§ 371 Date: Mar. 13, 2023

(30) Foreign Application Priority Data
Sep. 25, 2020 (JP) 2020-160596

(51) Int. Cl. G06T 7/00; G01N 21/88; G06V 10/774; G06V 20/70

(52) U.S. Cl. CPC G06T 7/0008; G01N 21/8851; G06V 10/774; G06V 20/70; G06T 2207/30164

(57) ABSTRACT

A model generation device generates a model used in visual inspection based on an image of a normal product. The model generation device generates abnormal image data by performing image processing on acquired normal image data, and generates label image data indicating an abnormal part based on the content of the image processing at that time. Then, the model generation device generates training data with the abnormal image data, as input data, and the normal image data and the label image data, as output data, and instructs a machine learning device to generate a learning model by performing machine learning based on the training data.

### TECHNICAL FIELD

The present invention relates to a model generation device for visual inspection and a visual inspection device.

### BACKGROUND ART

At manufacturing sites such as factories, visual inspections are performed on products manufactured on the manufacturing line (for example, Patent Literature 1). In order to perform the visual inspections of products, it is necessary to generate a machine learning model for performing classification into a normal product image or an abnormal product image based on captured images of products.

In generating such a machine learning model, many images of normal products and many images of abnormal products are respectively collected in advance. Then, machine learning is performed by using the collected images. For the images of abnormal products, in many cases, it is desirable to further specify which portion of the image is abnormal. In such a case, it is necessary to generate in advance a label image showing an abnormal part in the image of the abnormal product.

### CITATION LIST

### Patent Literature

Patent Literature 1: JP 2014-190821 A

### SUMMARY OF THE INVENTION

### Problem to be Solved by the Invention

Many of products manufactured at the manufacturing site are normal products. For this reason, it is easy to collect images of normal products. In contrast, abnormal products are manufactured relatively infrequently. For this reason, it is difficult to collect a number of images of the abnormal products. It is possible to collect a number of images of abnormal products by intentionally manufacturing the abnormal products, but there is a problem in terms of cost because the number of products to be discarded increases.

In addition, there are many types of abnormalities in products, such as uncut or overcut, degradation of surface quality due to tool wear, and partial breakage. However, because abnormal products are manufactured infrequently as described above, it is still difficult to collect images necessary for generating a machine learning model that can detect abnormalities in these various products. In addition, because these abnormalities may appear at different locations on the product, it is necessary to put in a lot of effort considering up to the collection of label images showing abnormal parts of abnormal products.

Therefore, there is a demand for a technology for easily generating a model for visual inspection based on images of normal products.

### Means for Solving Problem

A model generation device according to an aspect of the invention automatically generates images of abnormal products and label images indicating abnormal parts from images of normal products. Then, by using the generated images of abnormal products and the original normal product images, one model used for visual inspection is generated. The model to be generated is a model for estimating an image showing the original normal product image and another image showing at least one of an image showing an abnormal part and an abnormality probability, from the images of abnormal products. In order to generate such a model, a learning method that takes advantage of the characteristics of expression learning is used. More specifically, efficient and effective learning is performed by adding other images relevant to the label image to output data of the learning model in addition to the normal label image. The model generation device according to an aspect of the invention can automatically generate a model used in visual inspection based on one or more normal product image(s) by executing the above steps.

In addition, one aspect of the invention is a model generation device for generating a model used in visual inspection. The model generation device includes: a data acquirer for acquiring normal image data; an abnormal image generator for generating abnormal image data by performing image processing on the normal image data; a label image generator for generating label image data indicating an abnormal part based on content of image processing by the abnormal image generator; and a learning instructor for generating training data with the abnormal image data, as input data, and the normal image data and the label image data, as output data, and instructing a machine learning device to generate a learning model by performing machine learning based on the training data.

Another aspect of the invention is a visual inspection device for performing a visual inspection of a product based on an image of the product. The visual inspection device includes: a data acquirer for acquiring image data of the product; and an estimation instructor for instructing a machine learning device to estimate restored image data and label image data indicating an abnormal part from the image data of the product by using a learning model for estimating the restored image data and the label image data indicating an abnormal part from abnormal image data and outputting the estimated restored image data and label image data indicating an abnormal part.

### Effect of the Invention

According to one aspect of the invention, it is possible to greatly reduce the cost of collecting images of abnormal products. Therefore, it is possible to greatly reduce the cost of generating a model used in visual inspection.

### BRIEF DESCRIPTION OF DRAWINGS

FIG. 1 is a schematic hardware configuration diagram of a model generation device according to an embodiment;

FIG. 2 is a schematic functional block diagram of the model generation device according to the embodiment;

FIG. 3 is an example of generating abnormal image data by using a predetermined geometric image;

FIG. 4 is a diagram showing an example of masking;

FIG. 5 is a diagram showing an example of transforming a product image;

FIG. 6 is a diagram showing another example of transforming a product image;

FIG. 7 is a diagram showing an example of generating a label image;

FIG. 8 is a schematic functional block diagram of a model generation device according to a modification;

FIG. 9 is a schematic functional block diagram of a model generation device according to another modification; and

FIG. 10 is a schematic functional block diagram of a visual inspection device according to an embodiment.

### MODE(S) FOR CARRYING OUT THE INVENTION

Hereinafter, embodiments of the invention will be described with reference to the diagrams.

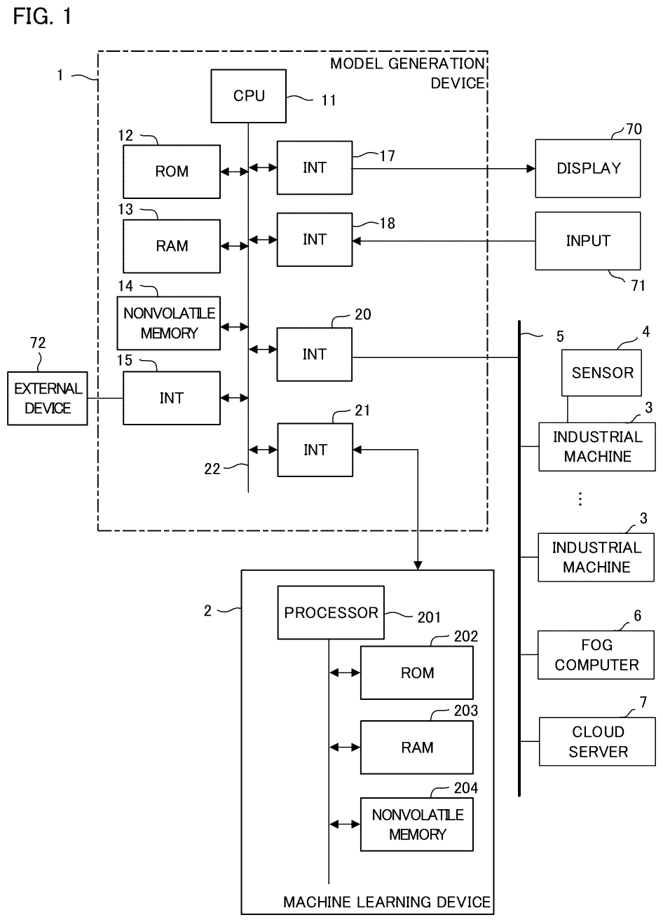

FIG. 1 is a schematic hardware configuration diagram showing a main part of a model generation device according to an embodiment of the invention.

A model generation device 1 according to the present embodiment can be mounted, for example, as a controller for controlling an industrial machine based on a control program, or can be mounted on a personal computer attached to the controller for controlling an industrial machine based on a control program or on a personal computer, a cell computer, a fog computer 6, or a cloud server 7 connected via a wired/wireless network to the controller. In the present embodiment, an example is shown in which the model generation device 1 is mounted on a personal computer connected to a controller through a network.

The model generation device 1 according to the present embodiment includes a CPU 11, which is a processor for performing overall control of the model generation device 1. The CPU 11 reads a system program stored in a ROM 12 through a bus 22 and performs overall control of the model generation device 1 according to the system program. Temporary calculation data or display data, various kinds of data input from the exterior, and the like are temporarily stored in a RAM 13.

A nonvolatile memory 14 is configured with, for example, a memory backed up by a battery, not shown, or an SSD (Solid State Drive), and its storage state is maintained even when the power of the model generation device 1 is turned off. The nonvolatile memory 14 stores data read from an external device 72 through an interface 15, data input through an input device 71, data acquired from an industrial machine 3 through a network 5, and the like. The stored data may include image data of a product imaged by a sensor 4, such as a visual sensor attached to the industrial machine 3, for example. The data stored in the nonvolatile memory 14 may be loaded to the RAM 13 at the time of execution/use. In addition, various system programs, such as a known analysis program, are written in the ROM 12 in advance.

The interface 15 is an interface for connecting the CPU 11 in the model generation device 1 and the external device 72, such as a USB device, to each other. From the external device 72 side, for example, data relevant to products manufactured by each industrial machine (for example, image data of normal products and CAD data indicating the shape of products) can be read. In addition, data and the like edited in the model generation device 1 can be stored in an external storage means, such as a CF card, through the external device 72.

An interface 20 is an interface for connecting the CPU in the model generation device 1 to the wired or wireless network 5. The industrial machine 3, a fog computer, a cloud server, and the like are connected to the network 5, so that the transmission and reception of data to and from the model generation device 1 are performed.

Data read into the memory, data obtained as an execution result of a program, data output from a machine learning device 2 to be described later, and the like are input and displayed on a display device 70 through an interface 17. In addition, the input 71 that is a keyboard, a pointing device, or the like transmits instructions, data, and the like based on the operation of the operator through an interface 18 to the CPU 11.

An interface 21 is an interface for connecting the CPU 11 and the machine learning device 2 to each other. The machine learning device 2 includes a processor 201 for overall control of the machine learning device 2, a ROM 202 for storing a system program and the like, a RAM 203 for temporary storage in each process relevant to machine learning, and a nonvolatile memory 204 used to store a learning model and the like. The machine learning device 2 can observe data (for example, image data of normal products, image data of abnormal products, and label data) that can be acquired by the model generation device 1 through the interface 21. In addition, the model generation device 1 acquires a processing result, which is output from the machine learning device 2 through the interface 21, to store and display the acquired result and further transmits the acquired result to other devices through the network 5 or the like.

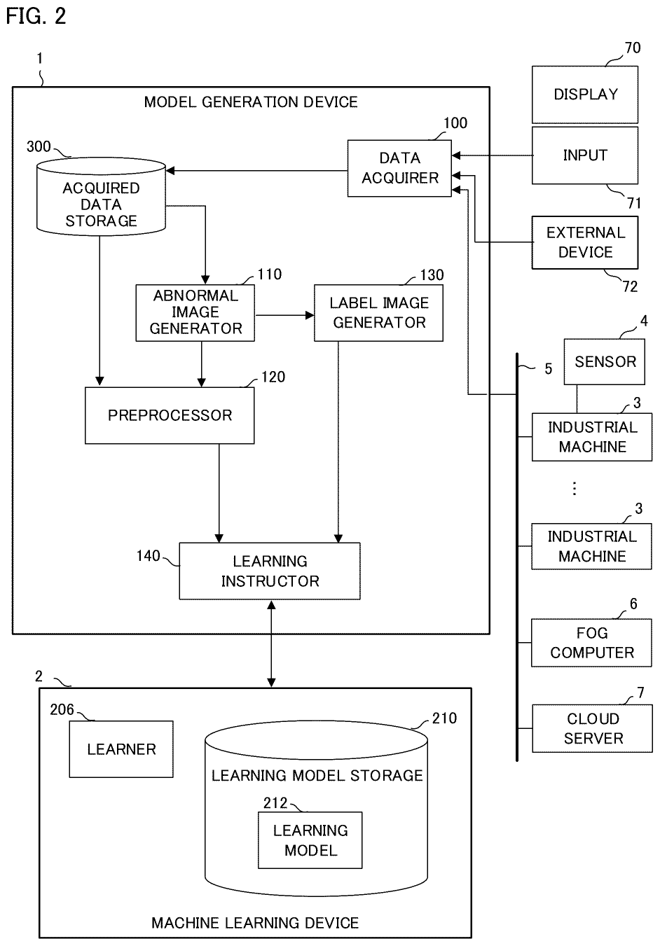

FIG. 2 shows, as a schematic block diagram, the functions of the model generation device 1 according to an embodiment of the invention.

Each function of the model generation device 1 according to the present embodiment is actualized in such a manner that the CPU 11 included in the model generation device 1 shown in FIG. 1 executes a system program and controls the operation of each unit in the model generation device 1.

The model generation device 1 of the present embodiment includes a data acquirer 100, an abnormal image generator 110, a preprocessor 120, a label image generator 130, and a learning instructor 140. In addition, the machine learning device 2 connected to the model generation device 1 includes a learner 206. In addition, in the RAM 13 or the nonvolatile memory 14 of the model generation device 1, an acquired data storage 300 is prepared in advance as a region for storing data acquired from the industrial machine 3 or the like by the data acquirer 100. In addition, in the RAM 203 and the nonvolatile memory 204 of the machine learning device 2, a learning model storage 210 is prepared in advance as a region for storing a learning model 212 generated by the learner 206.

The data acquirer 100 is actualized in such a manner that the CPU 11 included in the model generation device 1 shown in FIG. 1 executes a system program read from the ROM 12 and that the CPU 11 mainly performs arithmetic processing using the RAM 13 and the nonvolatile memory 14 and input control processing using the interfaces 15, 18, and 20. The data acquirer 100 may acquire image data of a product imaged by the sensor 4 attached to the industrial machine 3, or may acquire data directly from the industrial machine 3 through the network 5, or may acquire data acquired and stored by the external device 72, a fog computer 6, a cloud server 7, or the like. The data acquired by the data acquirer 100 includes at least image data of normal products (hereinafter, referred to as normal image data). The data acquired by the data acquirer 100 may include image data of abnormal products (hereinafter, referred to as abnormal image data). In this case, however, it is desirable that a label indicating normal image data and a label indicating abnormal image data are assigned to the image data acquired by the data acquirer 100. For example, the data acquirer 100 may acquire normal image data visually confirmed by the operator based on the operator's operation. In addition, the data acquirer 100 may receive the operator's operation and assign a label indicating normal image data and a label indicating abnormal image data to the acquired image data. The product image data acquired by the data acquirer 100 is stored in the acquired data storage 300.

The abnormal image generator 110 is realized in such a manner that the CPU 11 included in the model generation device 1 shown in FIG. 1 executes a system program read from the ROM 12 and that the CPU 11 mainly performs arithmetic processing using the RAM 13 and the nonvolatile memory 14. The abnormal image generator 110 generates abnormal image data based on the normal image data stored in the acquired data storage 300. For example, the abnormal image generator 110 may generate abnormal image data by superimposing a predetermined figure on a part of the image of the product in the normal image data. Furthermore, the abnormal image generator 110 may generate abnormal image data by performing image processing, such as changing the hue, saturation, and brightness of a part of the image or applying a mosaic, on the normal image data, or may generate abnormal image data by adding or cutting (transforming) a predetermined figure to or from the image of the product in the normal image data.

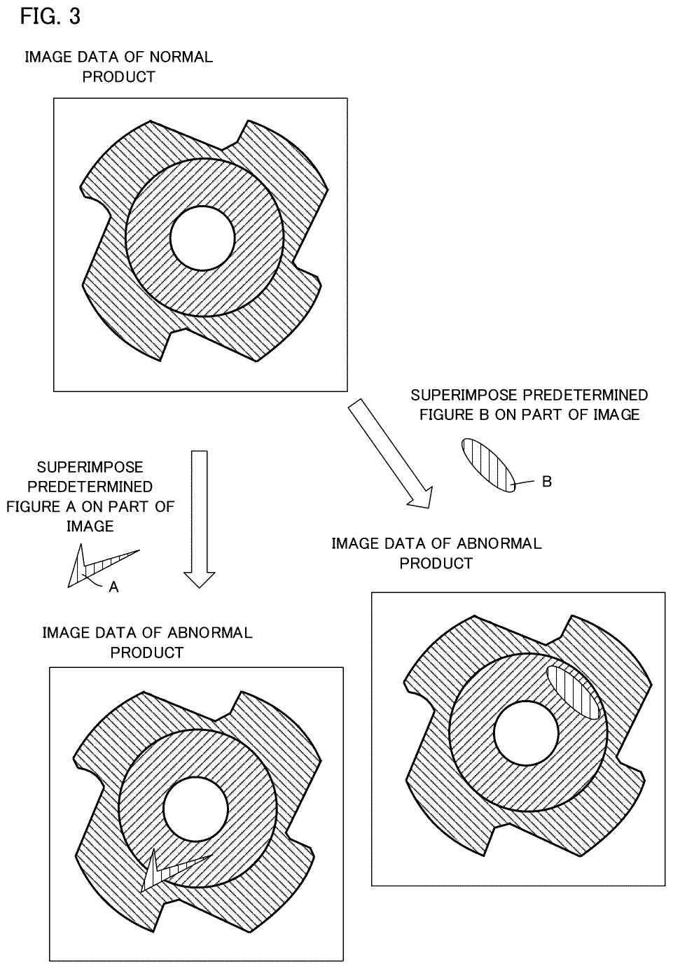

FIG. 3 is an example of generating abnormal image data by superimposing a predetermined figure (geometric figure) on a part of an image of a product in normal image data.

The predetermined figure to be superimposed may be stored in advance in the RAM 13 or the nonvolatile memory 14 of the model generation device 1, or a geometric figure may be generated as the predetermined figure at the stage of generating abnormal image data. The color of the predetermined figure may be a color similar to the color of the product as long as the color of the predetermined figure is different from the color of the product. The position of the product image where the predetermined figure is to be superimposed may be determined by, for example, calculating a random number value. The predetermined figure added in this manner expresses a portion where the processing quality of the product is degraded, a defective portion in the product, and the like.

When superimposing a predetermined figure on a product image, the abnormal image generator 110 may perform translucent composition with a predetermined transparency, or instead of superimposing the predetermined figure, may change the hue, saturation, or brightness in the range of the predetermined figure to be superimposed on the product image or may apply a mosaic. With either method, it is possible to express a portion subjected to different processing from normal product processing (a portion with reduced quality).

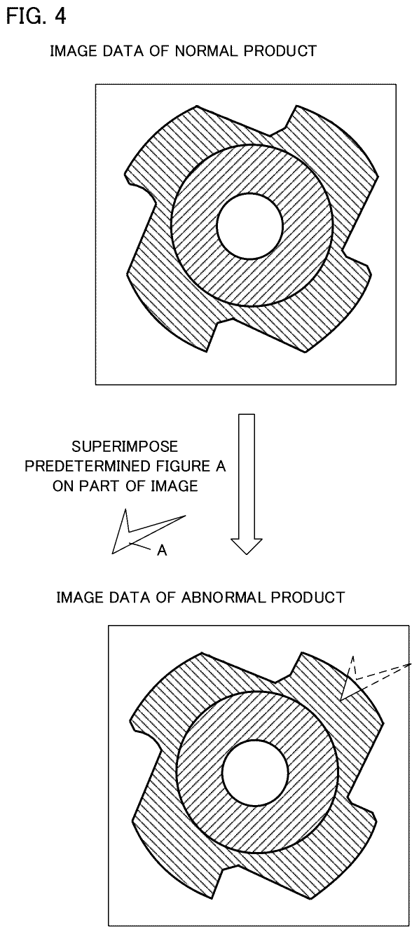

When superimposing a predetermined figure on a part of the image of the product in the normal image data, the abnormal image generator 110 may perform mask processing on the predetermined figure in consideration of the shape of the product. For example, as illustrated in FIG. 4, when a part of a predetermined figure protrudes from the image of the product, mask processing may be performed on the predetermined figure so that only the portion overlapping the image of the product is displayed. The range of the image of the product in the normal image data may be extracted from the normal image data by using a known method in which edge processing and the like are combined. In addition, the range of the image of the product in the normal image data may be extracted from the normal image data by matching processing based on CAD data or the like.

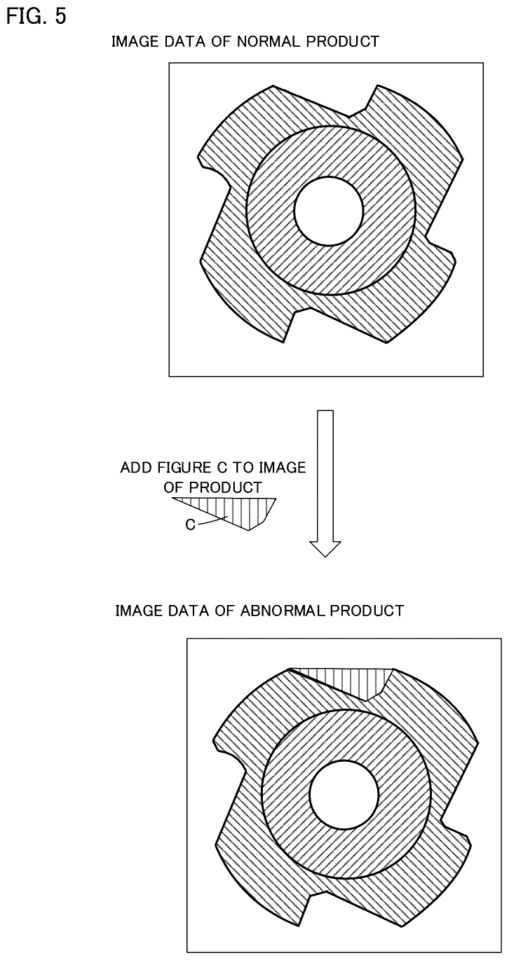

FIG. 5 is an example of generating abnormal image data by adding a predetermined figure to an image of a product in normal image data.

It is desirable that a predetermined figure to be added is arranged adjacent to the image of the product in the normal image data. The shape of the predetermined figure to be added may be stored in advance in the RAM 13 or the nonvolatile memory 14 in the model generation device 1, or a geometric figure may be generated as the predetermined figure at the stage of generating abnormal image data. It is desirable that a predetermined figure to be added is arranged adjacent to the image of the product in the normal image data. The color of the predetermined figure to be added may be a color similar to the color of the product. In addition, the position of the product image where the predetermined figure is to be added may be determined by, for example, calculating a random number value. The predetermined figure added in this manner expresses uncut, large burr, and the like of the product.

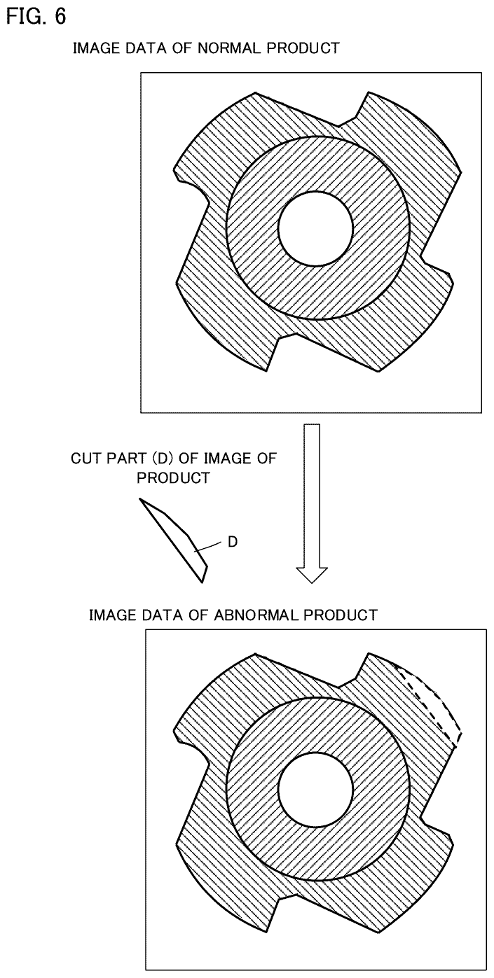

FIG. 6 is an example of generating abnormal image data by cutting a predetermined figure from an image of a product in normal image data.

The shape of the predetermined figure to be cut may be stored in advance in the RAM 13 or the nonvolatile memory 14 of the model generation device 1, or a geometric figure may be generated as the predetermined figure at the stage of generating abnormal image data. It is desirable that the predetermined figure to be cut is to cut the edges of the image of the product in the normal image data. The color of the predetermined figure to be cut may be a color similar to the background color in the normal image data. In addition, the position of the product image to be cut may be determined by, for example, calculating a random number value. The predetermined figure cut in this manner expresses defects, overcut, and the like of the product.

The abnormal image generator 110 may generate abnormal image data based on a plurality of pieces of normal image data stored in the acquired data storage 300. Alternately, the generator 110 may generate a plurality of pieces of abnormal image data by changing the predetermined figure shape or position to be superimposed, the shape or position of a figure to be added or cut, and the like based on one piece of normal image data. The abnormal image generator 110 generates a sufficient number of abnormal images for the machine learning device 2 to learn the abnormal parts of the product in the abnormal image data. The sufficient number for learning may be preferably set in advance by the operator.

The preprocessor 120 is actualized in such a manner that the CPU 11 included in the model generation device 1 shown in FIG. 1 executes a system program read from the ROM 12 and that the CPU 11 mainly performs arithmetic processing using the RAM 13 and the nonvolatile memory 14. The preprocessor 120 performs predetermined image processing on the normal image data stored in the acquired data storage 300 and the abnormal image data generated by the abnormal image generator 110. The predetermined image processing that the preprocessor 120 performs on the abnormal image data includes at least an image processing method that makes it easy to extract the features of normal image data/abnormal image data. For example, the preprocessor 120 may perform edge enhancement processing on the normal image data/abnormal image data so that the contours of objects or abnormal parts appearing in the normal image data/abnormal image data are easily identified. In addition, the preprocessor 120 may perform two-dimensional or three-dimensional rotation processing so that the postures or orientations of objects appearing in the normal image data/abnormal image data are approximately the same. The preprocessor 120 may perform processing for adjusting the brightness or saturation of the normal image data or abnormal image data so that the range of each part of objects appearing in the normal image data/abnormal image data becomes clear. In this manner, by applying the processing automatically performed by the human optical system (human vision) to the normal image data/abnormal image data, the accuracy of learning and estimation can be improved to some extent. In addition, the preprocessor 120 is not necessarily an essential component. However, the number of pieces of data required for image-based learning can be reduced by providing the preprocessor 120.

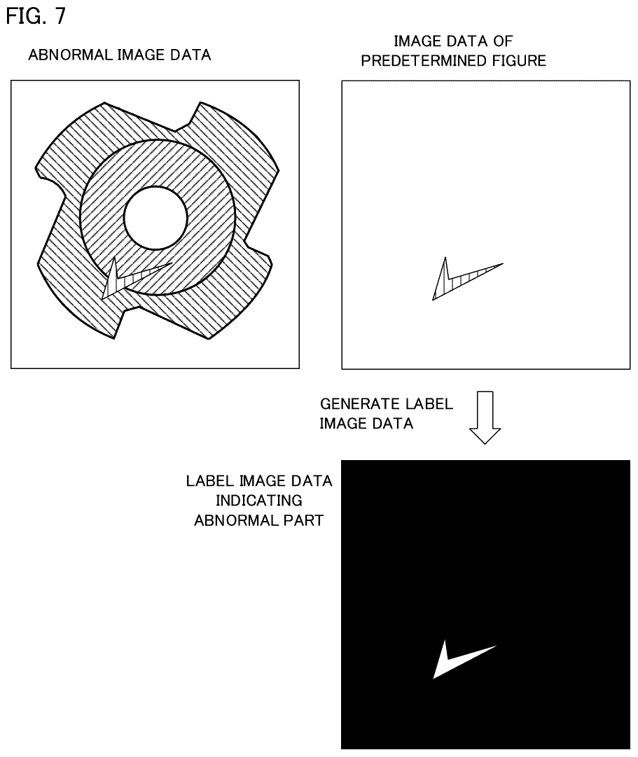

The label image generator 130 is actualized in such a manner that the CPU 11 included in the model generation device 1 shown in FIG. 1 executes a system program read from the ROM 12 and that the CPU 11 mainly performs arithmetic processing using the RAM 13 and the nonvolatile memory 14. The label image generator 130 generates label image data indicating an abnormal part based on a predetermined figure used to generate the abnormal image data. As illustrated in FIG. 7, the label image data may be generated as image data in which a part occupied by the predetermined figure in the image data is shown in a first color (for example, white) and the other parts are shown in a second color (for example, black). The label image data generated in this manner indicates the part shown in the first color as an abnormal part in the product image.

The learning instructor 140 is actualized in such a manner that the CPU 11 included in the model generation device 1 shown in FIG. 1 executes a system program read from the ROM 12 and that the CPU 11 mainly performs arithmetic processing using the RAM 13 and the nonvolatile memory 14 and input/output control processing using the interface 21. The learning instructor 140 instructs the machine learning device 2 to generate a learning model by performing learning based on abnormal image data preprocessed by the preprocessor 120, normal image data from which the abnormal image data is generated, and label image data generated by the label image generator 130. The learning instructor 140 generates, for example, a plurality of pieces of training data with abnormal image data as input data and normal image data, from which the abnormal image data is generated, and label image data as output data and instructs the machine learning device 2 to perform learning based on the generated training data.

Here, it should be noted that not only the label image data but also the normal image data from which the abnormal image data is generated is used as output data. In normal learning, it is sufficient to generate a model for inferring a label image from abnormal image data. However, in the case of such learning, there are many cases in which it is not possible to successfully find the features of an abnormal part in the abnormal image data simply by proceeding with the learning. Therefore, by adding the normal image data to the label image data indicating the abnormal part as the output data, a learning model is generated in which the normal image data and the label image data are estimated in parallel from the abnormal image data. In this manner, a structure for extracting the feature representation of the normal image data is generated in the learning model, and the structure is also used in estimating the label image data. Therefore, it is possible to accurately estimate the label image data indicating an abnormal part. In addition, by arranging the normal image data on the output data, in actually performing a visual inspection, it is possible to generate a learning model that makes it possible to estimate label image data indicating an abnormal part by using only image data captured by the industrial machine 3 (image data for which it is not known whether this is normal image data or abnormal image data) as an input to the learning model. In the case of using normal image data in order to estimate label image data, for example, there is a method of arranging the normal image data on the input data. In the learning model generated in this manner, however, label image data indicating an abnormal part cannot be estimated unless normal image data captured from normal components are prepared in addition to image data captured by the industrial machine 3. In this respect as well, the learning model generated according to the present embodiment is considered to be excellent.

The learner 206 included in the machine learning device 2 is actualized in such a manner that the processor 201 included in the machine learning device 2 shown in FIG. 1 executes a system program read from the ROM 202 and that the processor 201 mainly performs arithmetic processing using the RAM 203 and the nonvolatile memory 204. The learner 206 generates a learning model 212 by performing machine learning using training data in response to the instructions received from the learning instructor 140. The learner 206 stores the generated learning model 212 in the learning model storage 210. The machine learning performed by the learner 206 is known supervised learning. The learning model 212 is, for example, a multilayer neural network. The learning model 212 generated by the learner 206 is a model that has learned the correlation among abnormal image data, original normal image data, and label image data indicating an abnormal part. The learning model 212 comes to be a model for estimating the original normal image data and the label image data indicating the abnormal part from the abnormal image data. In addition, since the technology for estimating, on the basis of a piece of image data, other pieces of image data using the machine learning technology is already well known, detailed descriptions thereof will be omitted herein.

The model generation device 1 according to the present embodiment having the above-described configuration can automatically generate a model used in visual inspection by generating abnormal image data based on normal image data, which can be easily collected, and performing machine learning based on the generated abnormal image data. Therefore, since it is possible to greatly reduce the cost of collecting images of abnormal products in performing machine learning, it is possible to perform efficient machine learning. The model generation device 1 generates one learning model capable of estimating the normal image data and label image data indicating an abnormal part based on the abnormal image data. In this learning model, a structure for estimating the normal image data and a structure for estimating the label image data are voluntarily formed in the process of learning, and the feature representations estimated by the structures are utilized for each other. Therefore, learning can proceed efficiently and effectively. In addition, since one learning model can be used to estimate normal image data and to estimate a label image indicating an abnormal part, it is possible to efficiently use computer resources such as a processor, memory, and a nonvolatile memory.

As a modification of the model generation device 1 according to the present embodiment, the label image generator 130 may generate label image data by expressing a probability that each pixel in the abnormal image data belongs to a predetermined label or category (in the invention, an abnormal part in the product image) in different colors. In this case, the learning instructor 140 generates a plurality of pieces of training data with abnormal image data as input data and normal image data, from which the abnormal image data is generated, and label image data indicating the abnormality probability of an abnormal part as output data and instructs the machine learning device 2 to perform learning based on the generated training data. At this time, the learning model 212 may be implemented by using a known semantic segmentation technology for associating labels or categories (in the invention, abnormal parts in the product image) with pixels in the image data. In addition, the learning model 212 may perform a known image regression analysis to indicate the probability that each pixel in the image data is an abnormal part of the product image. In addition, because the technology relevant to the machine learning described above is already well known, detailed description thereof will be omitted herein.

Based on the image data captured by the industrial machine 3, the model generation device 1 according to this modification estimates label image data indicating an abnormal part in the image data in a predetermined color corresponding to the abnormality probability. Even in such a case, learning can efficiently and effectively proceed by arranging normal image data on the output data.

In addition, the label image generator 130 may generate, as label image data, both label image data indicating an abnormal part and label image data indicating an abnormality probability of an abnormal part in an image. In this case, the learning instructor 140 generates a plurality of pieces of training data with abnormal image data as input data and normal image data from which the abnormal image data is generated, the label image data indicating the abnormal part, and the label image data indicating the abnormality probability of the abnormal part as output data and instructs the machine learning device 2 to perform learning based on the generated training data. With such a configuration, in the learning model 212, a structure for estimating normal image data, a structure for estimating the label image data indicating the abnormal part, and a structure for estimating label image data indicating the abnormality probability of an abnormal part are voluntarily constructed in the process of learning, and the feature representations estimated by the structures are utilized for each other. Therefore, it is expected that learning will more efficiently and effectively proceed.

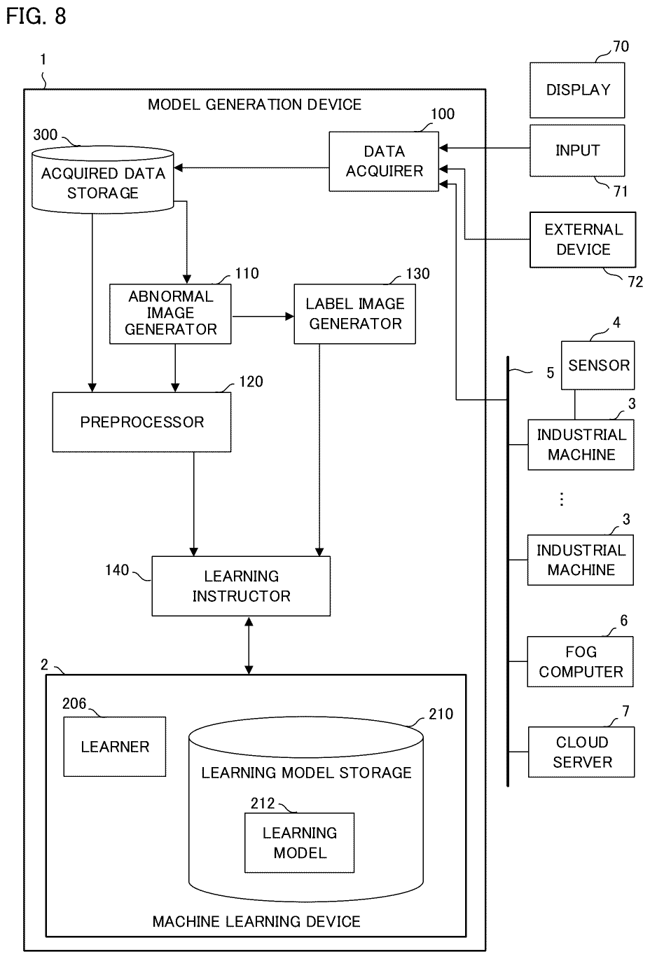

As another modification of the model generation device according to the present embodiment, as illustrated in FIG. 8, the model generation device 1 may include the machine learning device 2.

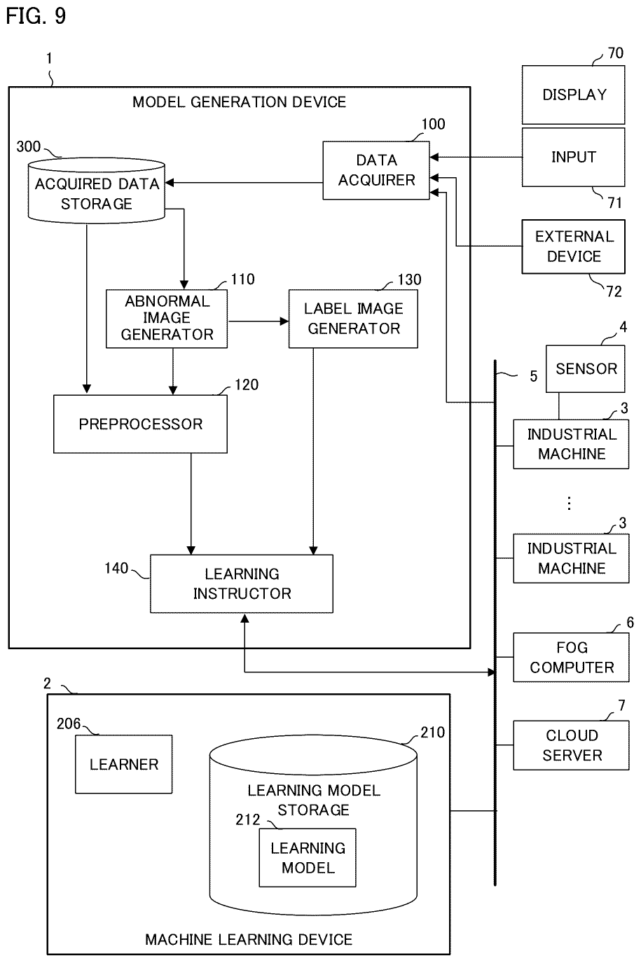

In addition, as illustrated in FIG. 9, a configuration in which the model generation device 1 and the machine learning device 2 are connected to each other through the network 5 can also be adopted. In the latter case, the machine learning device 2 may be mounted in a computer such as the fog computer 6 or the cloud server 7. In this manner, the machine learning device 2 can be shared by a plurality of operators, so that it is possible to reduce the cost for the introduction of the machine learning device 2.

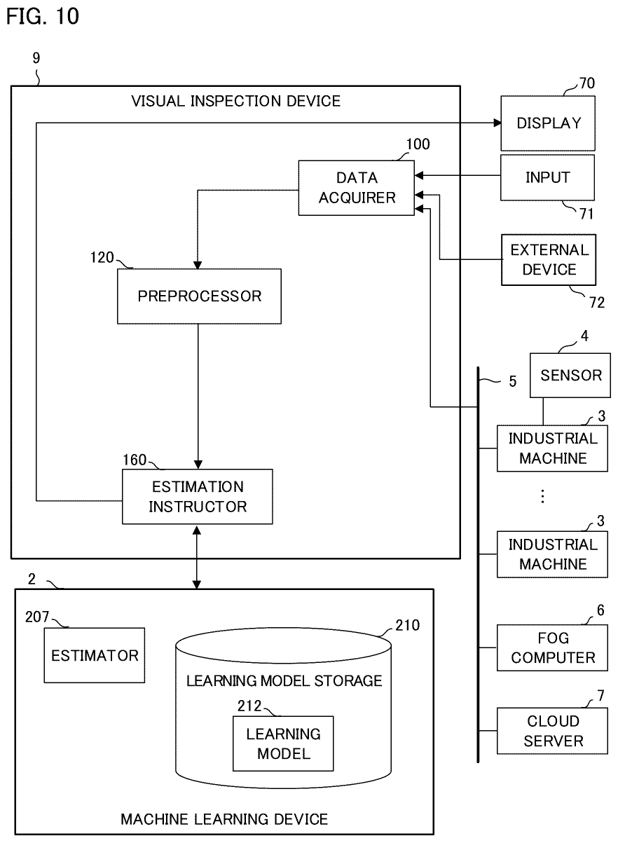

FIG. 10 is a schematic block diagram showing the functions of a visual inspection device 9 for performing visual inspection of a product using the learning model 212 generated by the model generation device 1 of the invention. Similar to the model generation device 1, the visual inspection device 9 according to the present embodiment can be mounted on a controller, a personal computer, a cell computer, the fog computer 6, the cloud server 7, and the like. In the following description, as with the model generation device 1, it is assumed that the visual inspection device 9 is mounted on a personal computer having the hardware shown in FIG. 1.

The visual inspection device 9 of the present embodiment includes a data acquirer 100, a preprocessor 120, and an estimation instructor 160. In addition, the machine learning device 2 connected to the visual inspection device 9 includes an estimator 207. In addition, on the RAM 203 and the nonvolatile memory 204 in the machine learning device 2, a learning model storage 210 is prepared in advance as a region for storing the learning model 212 generated by the model generation device 1.

The preprocessor 120 included in the visual inspection device 9 according to the present embodiment has functions similar to those of the preprocessor 120 included in the model generation device 1 described above.

The data acquirer 100 included in the visual inspection device 9 according to the present embodiment is actualized in such a manner that the CPU 11 provided in the model generation device 1 shown in FIG. 1 executes a system program read from the ROM 12 and that the CPU 11 mainly performs arithmetic processing using the RAM 13 and the nonvolatile memory 14 and input control processing using the interfaces 15, 18, and 20. The data acquirer 100 may acquire image data of a product imaged by the sensor 4 attached to the industrial machine 3, or may acquire data directly from the industrial machine 3 through the network 5, or may receive data acquired and stored by the external device 72, the fog computer 6, the cloud server 7, or the like. The data acquired by the data acquirer 100 may include image data of normal products and image data of abnormal products.

The estimation instructor 160 is actualized in such a manner that the CPU 11 included in the model generation device 1 shown in FIG. 1 executes a system program read from the ROM 12 and that the CPU 11 mainly performs arithmetic processing using the RAM 13 and the nonvolatile memory 14 and input/output control processing using the interface 21. Based on the image data acquired by the data acquirer 100, the estimation instructor 160 instructs the machine learning device 2 to estimate normal image data obtained by restoring the abnormal part of the image data (hereinafter, referred to as restored image data) and label image data indicating an abnormal part in the image data. The estimation instructor 160 receives the restored image data and label image data indicating an abnormal part estimated by the machine learning device 2 in response to the instruction. Then, the received restored image data and label image data are displayed on the display 70. The estimation instructor 160 may transmit the estimated restored image data and label image data indicating the abnormal part through a network to another computer.

The estimator 207 included in the machine learning device 2 is actualized in such a manner that the processor 201 included in the machine learning device 2 shown in FIG. 1 executes a system program read from the ROM 202 and that the processor 201 mainly performs arithmetic processing using the RAM 203 and the nonvolatile memory 204. The estimator 207 performs estimation processing using the learning model 212 based on the image data in response to the instruction received from the estimation instructor 160. The estimator 207 outputs, for example, the restored image data and the label image data indicating the abnormal part that are output from the learning model 212 with the image data that are input from the estimation instructor 160 as input data for the learning model 212, to the estimation instructor 160 as estimated data.

The visual inspection device 9 according to the present embodiment having the above-described configuration estimates a normal product image and an image showing an abnormal part from the product image through one-step processing using a learning model. The model used in estimation is generated by the model generation device 1 described above, and the effort for collecting abnormal image data in generating the model is no longer necessary. Therefore, the cost required to generate the model is greatly reduced compared with that in conventional arts. This means that a model capable of accurately performing visual inspection can be generated relatively quickly generated in manufacturing new parts. Therefore, accurate visual inspection using machine learning can be started from the initial stage of product development.

While an embodiment of the invention has been described above, the invention is not limited to the example of the embodiment described above, and can be implemented in various configurations by making appropriate modifications.

### EXPLANATIONS OF LETTERS OR NUMERALS

1 MODEL GENERATION DEVICE
2 MACHINE LEARNING DEVICE
3 INDUSTRIAL MACHINE
4 SENSOR
5 NETWORK
6 FOG COMPUTER
7 CLOUD SERVER
9 VISUAL INSPECTION DEVICE
11 CPU
12 ROM
13 RAM
14 NONVOLATILE MEMORY
17, 18, 20, 21 INTERFACE
22 BUS
70 DISPLAY
71 INPUT
72 EXTERNAL DEVICE
100 DATA ACQUIRER
110 ABNORMAL IMAGE GENERATOR
120 PREPROCESSOR
130 LABEL IMAGE GENERATOR
140 LEARNING INSTRUCTOR
160 ESTIMATION INSTRUCTOR
201 PROCESSOR
202 ROM
203 RAM
204 NONVOLATILE MEMORY
206 LEARNER
207 ESTIMATOR
210 LEARNING MODEL STORAGE
212 LEARNING MODEL
300 ACQUIRED DATA STORAGE

1. A model generation device for generating a model used in visual inspection, comprising:
a data acquirer for acquiring normal image data;
an abnormal image generator for generating abnormal image data by performing image processing on the normal image data;
a label image generator for generating label image data indicating an abnormal part based on content of image processing by the abnormal image generator; and
a learning instructor for generating training data with the abnormal image data, as input data, and the normal image data and the label image data, as output data, and instructing a machine learning device to generate a learning model by performing machine learning based on the training data.

2. The model generation device according to claim 1, comprising the machine learning device, wherein
the machine learning device includes a learner for generating the learning model in response to an instruction from the learning instructor.

3. The model generation device according to claim 1, wherein
the label image data is label image data indicating an abnormality probability of an abnormal part.

4. A visual inspection device for performing a visual inspection of a product based on an image of the product, comprising:
a data acquirer for acquiring image data of the product; and
an estimation instructor for instructing a machine learning device to estimate restored image data and label image data indicating an abnormal part from the image data of the product by using a learning model for estimating the restored image data and the label image data indicating an abnormal part from abnormal image data and outputting the estimated restored image data and label image data indicating an abnormal part.
